(19) United States
(12) Patent Application Publication
(10) Pub. No.: US 2022/0135458 A1
(43) Pub. Date: May 5, 2022

(54) SLUDGE FREE ONSITE SEWAGE TREATMENT SYSTEM

(71) Applicants: Nathan Hays, Anaheim Hills, CA (US); Jake Elliot, Aliso Viejo, CA (US)

(72) Inventors: Nathan Hays, Anaheim Hills, CA (US); Jake Elliot, Aliso Viejo, CA (US)

(21) Appl. No.: 16/488,046

(22) PCT Filed: Feb. 23, 2018
(86) PCT No.: PCT/US2018/019381

§ 371 Date: Aug. 22, 2019

Related U.S. Application Data
(60) Provisional application No. 62/463,158, filed on Feb. 24, 2017.

(51) Int. Cl. C02F 3/30; C02F 3/00; C02F 1/32; C02F 3/12

(52) U.S. Cl. CPC C02F 3/301; C02F 3/006; C02F 2001/007; C02F 3/1278; C02F 1/325

(57) ABSTRACT

The invention relates to a system and method for transforming raw sewage into a reusable water product that is substantially free of solids, naturally disinfected and does not require pumping.

### CROSS REFERENCE TO RELATED APPLICATIONS

This application claims the benefit of U.S. Provisional Application No. 62/463,158, filed Feb. 24, 2017, entitled ADVANCED SEWAGE TREATMENT SYSTEM. The entire content of the foregoing is hereby incorporated by reference herein.

### BACKGROUND

In the past, septic tanks have been used for the disposition of sewage. However, septic tanks, as is well known, are subject to malfunctioning, and are also subject to over flowing. Alternative systems often produce sludge and would still need to be pumped out like traditional septic tanks. Previous systems require that any treated water/effluent be discharged to a disposable area.

An objective of the present invention provides a means to break down all sludge and naturally disinfect the water. This enables the tank to, for example, now reuse the water for crops and irrigation instead of discharge the water to a disposable area. The solids no longer need to be pumped from the system which can enable the tank to require little or no maintenance. The system is substantially free of the operational disadvantages of septic tanks and other prior art sewage disposal units.

### SUMMARY OF INVENTION

The sewage disposal unit can include a rectangular container having first and second ends, and a removable top on which first, second and third man hole covers are secured by fastening means to span first, second and third access openings. The container can be buried in the ground at such depth that the cover is between 12″ to 36″ below the ground surface.

First, second and third transverse partitions can be provided within the container and so longitudinally spaced from one another that the interior of the container is subdivided to define a first chamber, a second chamber, and a holding tank. The access openings can be spanned by the first, second and third manhole covers, which are in communication with the first chamber, second chamber, and the holding tank.

A raw sewage inlet in the first chamber can be connected by a first line that extends to the sewage discharge of the dwelling, residence or building to be serviced by the unit.

First and second tubes can extend downwardly into the first and second chambers, where tubes are connected to a motor-driven air pump or blower. The motor can have a timing mechanism associated therewith, and as a result pressurized air is discharged to the first and second tubes intermittently for desired periods of time.

The first chamber can have an overflow line extending therefrom to the second chamber.

When air is discharged under pressure from the first and second tubes, the air can become temporarily entrained with the sewage in the form of bubbles to define columns of sewage and bubbles that are lighter than the balance of the sewage. The heavier sewage tends to move such columns upwardly in the first and second chambers, and as a result the sewage in the first and second chambers is caused to flow in closed paths in opposite directions. A number of spaced first baffles are provided in the first chamber.

These first baffles can have corrugated surfaces that are contacted by solids of substantial size in the sewage. The solids as a result of this contact are substantially reduced in size.

The sewage as it enters the first chamber contains both aerobic and anaerobic bacteria. During the time that air is discharged into the first chamber the sewage is aerated, and the growth of aerobic bacteria is stimulated to partially disintegrate the raw sewage. This disintegration is encouraged due to the turbulence created as the sewage flows in a closed path, and all parts of the sewage being exposed to the bacterial action of the aerobic microorganisms.

After the sewage in the first chamber has been aerated for a period of time, the aeration is terminated. The partially disintegrated sewage in the first chamber is now substantially devoid of free oxygen, and the growth of anaerobic bacteria is encouraged. As the anaerobic bacteria multiply they further disintegrate the sewage, and decompose portions of the sewage not attacked by the aerobic bacteria.

As additional raw sewage flows into the first chamber it displaces partially disintegrated sewage that by an overflow pipe is transferred to the second chamber. The second chamber can include an aeration section and a settling section. In the settling section, the water is generally not exposed to aeration. In this section, remaining solids can naturally separate. Once those solids separate, they can fall into a restricted passage at the bottom of the chamber, which accelerates them back into the aeration section (where they are aerated and pushed through more corrugated surfaces). The partially disintegrated sewage can be again treated in time-spaced cycles of action by aerobic and anaerobic bacteria. The partially dissolved solids can be allowed to be exposed to further aeration and some of this water then enters the settling section where the sludge is allowed to separate and recirculate back into the above described aeration/corrugated surface motion. This cycling of remaining solids can continue to occur until all solids are dissolved. This repeated cycling of solids, and the physical separation between the location where the solids settle and are recycled, and the location where the solid-free water exits the second chamber, permits the system to produce outlet water that is substantially free of solids.

The final effluent/output water can be free of sludge and naturally disinfected.

Some embodiments of the invention relate to a system for purifying a waste product including an operating cycle used in a sewage treatment apparatus. In some embodiments, the sewage treatment apparatus can include a sewage treatment unit including a first chamber and a second chamber. In some embodiments, the first chamber and an aeration portion of the second chamber are capable of aerating the raw sewage. In some embodiments, the operating cycle can include aeration for aerobic treatment for about 8 to about 12 hours and anaerobic treatment for about 12 to about 16 hours.

In some embodiments, the system can include a disinfecting unit. The disinfecting unit can be a UV disinfecting unit, or similar.

In some embodiments, the system can include a telemetry system. In some embodiments, the telemetry system can communicate with a data system.

In some embodiments, a cloud based web application can monitor the system.

In some embodiments, the cloud based web application can monitor one or more parameters selected from the group including: monitor water flow, broken sump pump, blowers, disinfection unit(s), and/or the like.

In some embodiments of the system, the waste product is raw sewage, or the like.

In some embodiments, pumping of the waste product or output water is not required.

In some embodiments, the system can produce an output water that is suitable for re-use, for example, for crops, irrigation, flushing toilets, and/or similar.

Some embodiments of the invention relate to a method for processing a waste product. The method can include passing water through the system of the invention, wherein aeration occurs in the first chamber and in an aeration portion of the second chamber. In some embodiments, settling and recirculation of solids occurs in a settling portion of the second chamber, and any remaining solids are exposed repeatedly to agitation and aeration until the solids are substantially broken down into liquid components. In some embodiments, aeration can be of a duration of time sufficient to promote aerobic microorganism processes that promote processing of the waste. In some embodiments a cessation of aeration can occur during a period of time sufficient to promote the action of anaerobic microorganisms that also promote processing of the waste.

In some embodiments, the operating cycle can include alternating between aeration and non-aeration.

In some embodiments, the method can produce output water that is a substantially solids-free and contaminant-free.

In some embodiments, pumping of the waste product or output water is not required.

In some embodiments, the output water can be suitable for re-use.

### BRIEF DESCRIPTION OF THE DRAWINGS

Those of skill in the art will understand that the drawings, described below, are for illustrative purposes only. The drawings are not intended to limit the scope of the present teachings in any way. Embodiments of the invention are disclosed herein, in some cases in exemplary form or by reference to one or more figures which in some cases may make references to certain exemplary dimensions or measurements. However, any such disclosure of a particular embodiment is exemplary only, and is not indicative of the full scope of the invention.

FIG. 1 depicts a top plan view of a unit.

FIG. 2 depicts a top plan view of the unit.

FIG. 3 depicts a longitudinal cross sectional view of the unit.

FIG. 4 depicts exemplary measurements for parts of the unit.

FIG. 5 depicts exemplary measurements for parts of the unit.

FIG. 6 depicts exemplary measurements for parts of the unit.

FIG. 7 depicts exemplary measurements for parts of the unit.

FIG. 8 depicts exemplary measurements for parts of the unit.

FIG. 9 depicts exemplary measurements for parts of the unit.

### DETAILS OF INVENTION

The invention relates to a system and method for transforming raw sewage into a water product that is free of sludge and is naturally disinfected.

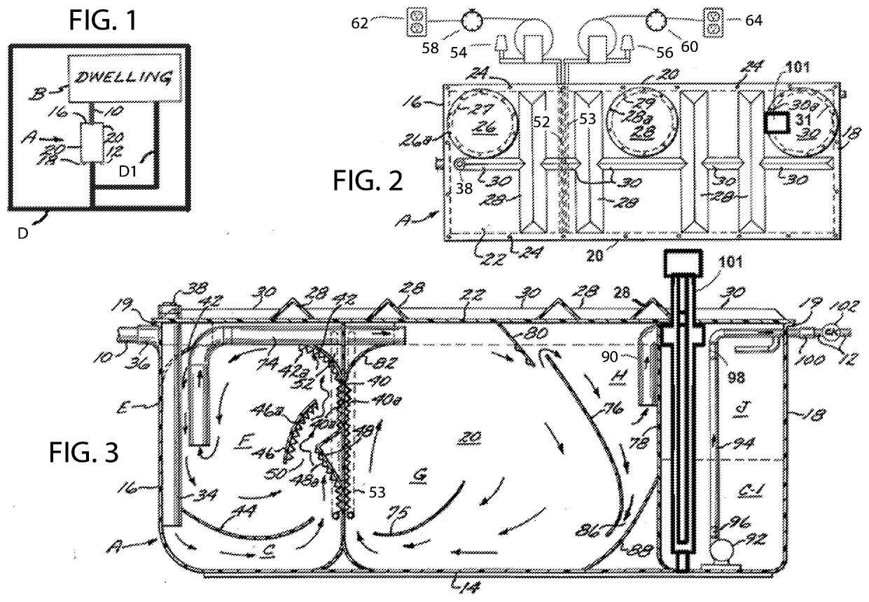

The sewage treatment unit A can be seen in FIG. 1 and is connected by an underground line or any inlet 10 to a dwelling B to receive sewage C from the latter, with the sewage after being treated in the unit discharging as a substantially colorless and odorous effluent C-1 therefrom to a line 12 that can extend to a drip irrigation system D, or reused in the dwelling B through any application D-1.

The unit A can include a rectangular container E that is formed from fiberglass or other suitable material that is inert to bacteria, moisture and water. The system can be rectangular on the inside of the tank, but need not be of any particular shape on the outside. Container E can have a bottom 14 connected to first and second end walls 16 and 18, and a pair of side walls 20. The end walls 16 and 18 and pair of side walls 20 can terminate on their upper ends in a continuous outwardly extending flange 19. A rectangular top 22 can rest on flange 19 and is removably secured thereto by a number of spaced bolts 24.

First, second and third manhole covers 26, 28 and 30 can rest on top 22 and span longitudinally spaced first, second and third access openings 27, 29 and 31 formed in the top as seen in FIG. 2. The manhole covers 26, 28 and 30 can be removably secured to top 22 by first, second and third sets of bolts 26a, 28a, and 30a. Top 22 for reinforcing purposes can have transverse ribs 28 and a longitudinal rib 30 integrally formed as a part thereof. Container E adjacent first end wall 16 can have a raw sewage inlet pipe 34 extending downwardly therein. Pipe 34 by a fitting 36 can be connected to line 10. The fitting 36 can include a clean out opening that is closed by a removable plug 38.

A first transverse partition 40 can extend between the side walls 20 as shown in FIG. 3 and cooperates with bottom 14, top 22 and first end wall 16 to define a first chamber F. Both sides of the first partition 40 can have transverse corrugations 40a found thereon. Two transverse arcuate diffuser baffles 42 can extend between the pair of side walls 20 adjacent the partition 40 and first end wall 16 as shown in FIG. 3, and the diffusion baffle 42 adjacent first partition 40 having transverse corrugations 42a formed thereon. An arcuate return baffle 44 can extend transversely between sidewalls 20 and adjacent bottom 14 as shown in FIG. 3. Two additional baffles 46 and 48 can extend transversely between side walls 20. The baffles 46 and 48 can have transverse corrugations 46a and 48a on the adjacent sides thereof. Baffles 46 and 48 can cooperate to define a passage 50 there-between.

Two pipes 52 and 53 can enter the tank through the side wall above the highest water level and run downward into the first chamber F and second chamber G. Pipes 52 and 53 can continue down and then run horizontally near the bottom of the tank and can be perforated. The two pipes 52 and 53 can be independently connected to two separate blowers 54 and 56 outside of the tank that are positioned as needed to dwelling/site specific requirements. Blowers 54 and 56 can be connected to two timers 58 and 60 that operate the blowers in timed increments. Timers 58 and 60 can be connected to power sources 62 and 64. Alternatively, the two pipes can be connected to a single, shared blower and each pipe can have a valve controlling whether air from the blower reaches the pipe at any given time, wherein the valves are controlled by timers and/or a higher-level controller controlling various functions of the system.

When blower 54 is operating, air can be discharged in the form of bubbles from the horizontal perforated portions of 52. This in turn can create a column of sewage in first chamber F with which the bubbles are entrained that is lighter than the balance of the sewage. The heavier sewage flows to displace this lighter column and move the latter upwardly, and in so doing the sewage C in first chamber F is placed in turbulent motion to flow in the first closed path indicated by the arrows in FIG. 3.

The timer 58 can be set to intermittently close the electric circuit for time periods, and during each such period air is discharged into the first chamber F. The time periods per cycle can be 5, 6, 7. 8. 9 or more hours. As the raw sewage C is caused to circulate in first chamber F, solid portions thereof that are of substantial size are brought into forceful contact with corrugations 42a, 46a and 48a and broken into smaller parts.

The raw sewage C as it enters first chamber F can contain both aerobic and anaerobic bacteria. During the discharge of air into first chamber F, the growth of aerobic bacteria is encouraged, and these bacteria attack the sewage to partially disintegrate the same. During the time periods that air is not discharged into first chamber F, the partially disintegrated sewage therein is substantially free of oxygen and the growth of anaerobic bacteria is encouraged. The anaerobic bacteria attack portions of the partially disintegrated sewage that were immune to action by the aerobic bacteria.

As additional raw sewage C flows into the first chamber F, the partially disintegrated sewage displaced thereby can flow through an L-shaped overflow pipe 74 into a second chamber G. A transverse weir baffle 76 and a second transverse partition 78 can cooperate with the pair of side walls 20, top 22 and bottom 14 to define the second chamber G and a settling section H. A transverse skimmer 80 can be located in second chamber G adjacent the top of weir baffle 76. An arcuate diffuser 82 can extend transversely in second chamber G between pair of side walls 20 and adjacent the upper portion of first partition 40.

The timer 56 can also be set to intermittently close the electric circuit for time periods, and during each such period, air can be discharged into the second chamber G. The time periods per cycle can be 5, 6, 7, 8. 9 or more hours. The second tube 53 (as mentioned before) can be connected to blower 56 and discharges air in the form of bubbles into chamber G. This causes turbulent circulation of the partially disintegrated sewage in the chamber G, with the sewage that has not previously been disintegrated prior to entering the second chamber G being disintegrated by aerobic and anaerobic bacteria while in the second chamber. The direction of flow of partially disintegrated sewage in the second chamber G in a second path during the time that air is discharged into the second chamber is indicated by arrows in FIG. 3. Sewage as it flows in the second closed path can move upwardly along the first partition 40, along the tap 22, down the weir baffle 76 across bottom 14 and under a fourth baffle 75, and then upwardly along the first partition. The settling section H can receive effluent that flows over the weir 76, and can subject the same to a final cleaning action. Floating particles that remain in the effluent are separated therefrom by the increased velocity of the effluent as it flows through the restricted passage 86 defined by the lower portion of weir baffle 76 and a curved baffle 88 that merges with second partition 78 as may best be seen in FIG. 3. A second L-shaped overflow pipe 90 that extends through the upper portion of second partition 78 allows substantially colorless and odor free effluent to flow from settling section H through a disinfection unit 101 to holding tank J. The second L-shaped overflow pipe 90 can extend approximately 5-25 inches down through the upper portion of the second partition, for example, the second L-shaped overflow pipe 90 can extend approximately 12 inches down through the upper portion of the second partition.

The disinfection unit can be an UV disinfection unit, an Ozone disinfection unit, or any other disinfection unit, or any combination thereof.

A motor driven submersible pump 92 can be located in the lower portion of holding tank J and is supplied with electric power by conductors (not shown). The pump 92 has an effluent discharge line 94 connected thereto, and this line having a foot valve 96 and pressure relief valve 98 therein.

The discharge line 94 by a union 100 can be connected to the line 12 that extends to the drip irrigation D or through a site specific reuse application D1 that runs back to the dwelling B. An air vent line 102 can be connected to line 94 to prevent effluent being siphoned back into the holding tank J. A check valve 102 can be provided in line 12 to further prevent backflow of effluent into the holding tank J.

Optional details of a sewage treatment apparatus can be found, for example in U.S. Pat. No. 4,139,471, which is hereby incorporated by reference in its entirety.

The full operating cycle can include the aerobic, anaerobic, ozone formula, and UV treatment of waste in a self-contained system with all dosages.

The operating cycle can include aeration for aerobic treatment for 7, 8, 9, 10, or more hours. The operation cycle can include anaerobic treatment for 10, 11, 12, 13, 14, 15, 16 or more hours. The operating cycle can include aeration for aerobic treatment for 8 to 12 hours and anaerobic treatment for 12 to 16 hours.

The system can include disinfection in any of the chambers of the system. Methods of disinfection can include UV, Ozone, or any other form of disinfection, or any combination thereof to treat the water.

The system can include a telemetry system. The telemetry system can keep track of gallons of influent/effluent, amount treated, and/or system errors/malfunctions. The telemetry system can generate live data to alert of errors and schedule maintenance. The telemetry system can have capabilities to communicate with APIs and other data systems to integrate into a “smart-home.”

A cloud based web/smart phone application can monitor the system. The application can monitor water flow, broken sump pump, blowers, disinfection unit(s), or the like, or combinations thereof. The web/smart phone application can allow users to call for service and/or maintenance. The system can operate without ever pumping and only requires occasional maintenance over a period of time. The period of time can be 1, 2, 3, 4, 5, or more years.

The resulting effluent of the system can be used as irrigation or re-flushing a toilet and any other general re-uses of the water. A carbon filter can be used to produce drinking water.

The system can be a modular design. For example, parts such as the ozone generator, blowers used for aeration, pump for removing the water from the holding chamber, disinfection treatment unit, carbon filter, power unit, plumbing, manhole covers, telemetry system, etc. can be removed/replaced in the system.

The system can vary in size as a scalable septic design. For example, the system can be made as small as a fish tank treatment device, all the way up to a large commercial use including multiple large tanks.

The system can be used in single family homes, manufactured homes, mobile homes, multi-family homes, commercial, automobiles (such as but not limited to RVs), porta-potties, fish tanks, aerospace (airplanes and spaceships), boats (military, luxury, cruise liners, cargo), oil rigs, military barracks, temporary structures, etc.

Embodiments of the invention also contemplate a method for processing of sewage and like wastes that can result in a substantially solids-free, substantially contaminant-free output suitable for irrigation or for subsequent relatively simple treatment to achieve potability of the output water. The method can include passing water through the system described herein, including three chambers, wherein aeration occurs in the first and in an aeration portion of the second chamber, and wherein setting and recirculation of solids occurs in a settling portion of the second chamber, such that any remaining solids are exposed repeatedly to agitation and aeration until such solids are ultimately broken down into liquid components. Aeration in the method is of a duration sufficient to promote aerobic microorganism processes that promote processing of the waste, while the method also includes a cessation of aeration during a period of time sufficient to promote the action of anaerobic microorganisms that also promote processing of the waste. The method therefore alternates between aeration and non-aeration, in durations that permit activity, alternately, of aerobic and anaerobic processes. When inlet water has been processed and substantially separated from solids, it can flow into a chamber wherein further processing occurs, which processing renders the water sufficiently free of contaminants and organisms to be suitable for irrigation or for further processing to render the product water potable.

Substantially solids-free effluent/output water can be define as effluent/output water having substantially no solids, for example, less than 15%, 10%, 1%, 0.5%, 0.1% or less solids. Substantially contaminant-free effluent/output water can be define as effluent/output water having substantially no contaminants, for example, less than 25%, 20%, 15%, 10%, 1%, 0.5%, 0.1% or less contaminants.

### EXAMPLES

The following non-limiting example is provided to further illustrate embodiments of the invention described herein. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the instant disclosure, appreciate that many changes can be made in the specific embodiments that are disclosed and still obtain a like or similar result without departing from the spirit and scope of the application.

### Example 1

### Ozone Operating Cycle

Details of the entire ozone operating cycle are provided below (does not include alternate cycle for UV):
Anaerobic cycle time: 12 to 16 hours per day. Initial BOD and TSS reduction during this cycle is approximately 30%
Aerobic cycle time: 8 to 12 hours per day
Pounds of O₂ diffused per 8 hour cycle is 27.7
Oxygen transfer efficiency is 10% to 12%
Disinfectant: Ozone
Points of application: Head of ozone contact chamber
Level of Disinfection: Basic
Dosage: 1 to 2 ppm
Demand: 0.8 ppm.
Average total Ozone residual: >0.5 ppm after 30 minutes contact time.

### Example 2

### Dimensions

Exemplary dimension are provided in this example. The disclosure of a particular dimension is exemplary only, and is not indicative of the full scope of the invention.

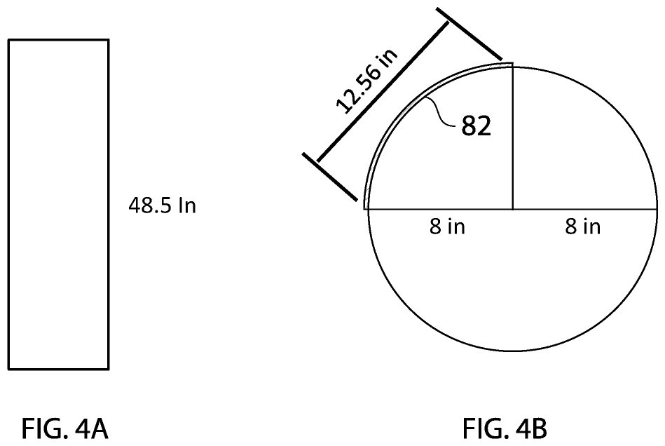

FIG. 4 shows the top view and side view of the 3 corners (upper left, and bottom two) in chamber 1 and the first two corners in chamber 2. The side view image shows a curved angle based off of a circle with a diameter of 16 inches and a circumference of 50.24 inches. In this example, ¼ of the circle circumference is measured out equal to 12.56 in. The top view image shows the width of the baffle being around 48.5 inches. Thickness can vary.

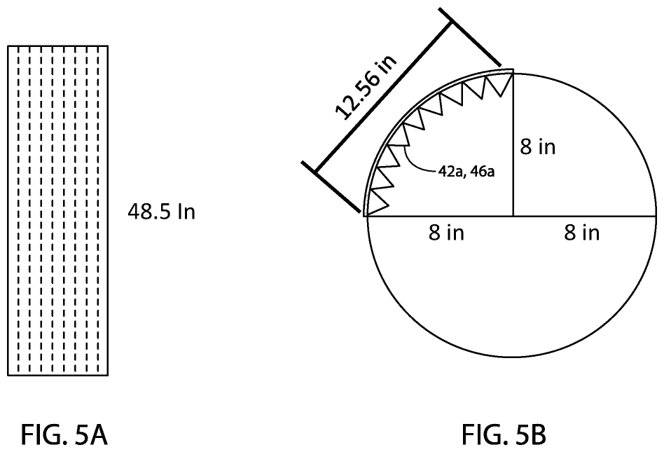

FIG. 5 shows the top view and side view of the top right corner in chamber 1 with corrugation and the suspended corrugated baffle in chamber 1. In this example, both baffles have the same dimensions. The side view image shows an curved angle based off of a circle with a diameter of 16 inches and a circumference of 50.24 inches. In this example, ¼ of the circle circumference is measured out equal to 12.56 in. This image also contains visible corrugation measured at 1.5 in on each side of the corrugated teeth (refer to slide eight). There are no spaces between the corrugated teeth and the row of teeth run the entire length and width of the baffle. The top view image shows the width of the baffle being around 48.5 inches. Thickness can vary.

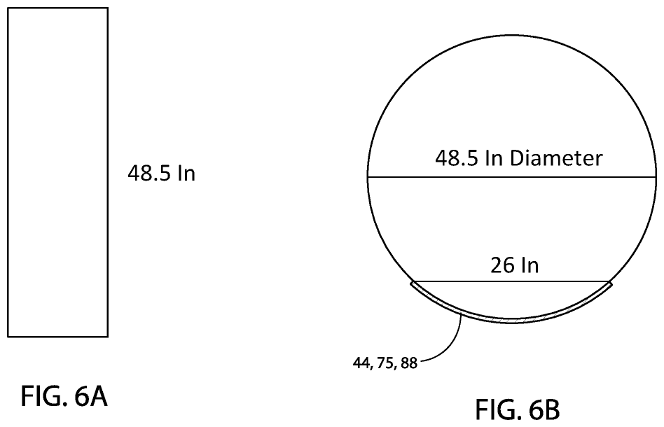

FIG. 6 shows the top view and side view of the lower suspended baffle in chamber (44) lower suspended baffle in chamber 2 (75) and the lower right hand corner in chamber 2 (88). In this example, all three baffles have the same dimensions. The side view image shows an curved angle based off of a circle with a diameter of 48 inches. In this example, the circumference of the circle is measured and cut at 26 inches around. The top view image shows the width of the baffle being around 48.5 inches. Thickness can vary.

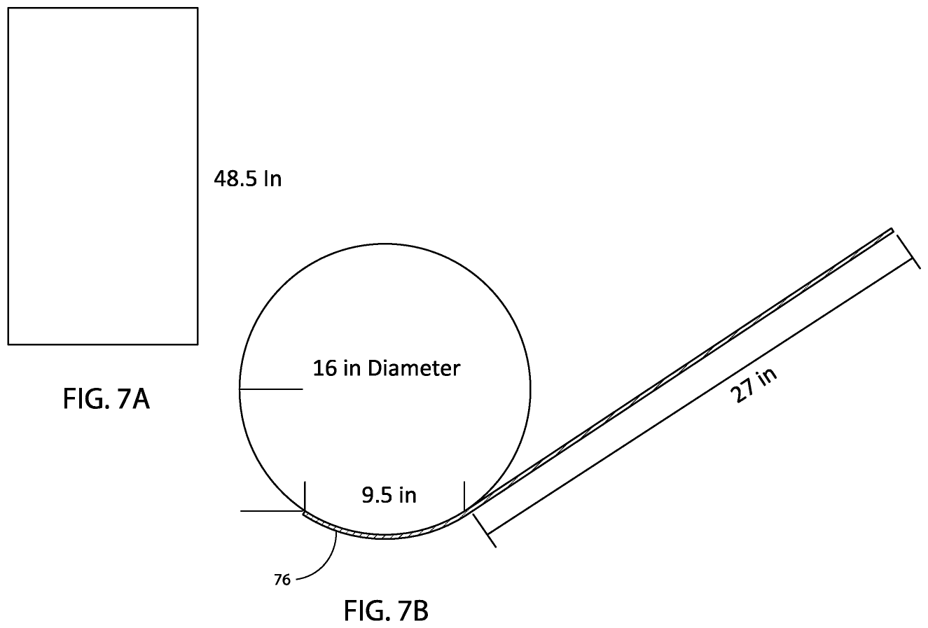

FIG. 7 shows the top view and side view of the largest suspended baffle in chamber 2. The side view image shows the first portion of the baffle which is a curved angle based off of a circle with a diameter of 16 inches. In this example, the circumference of the circle must be measured and cut at 9.5 in around to get the accurate length and degree. The baffle then straightens out and runs to a length of 27 inches. The top view image shows the width of the baffle being around 48.5 inches. Thickness can vary.

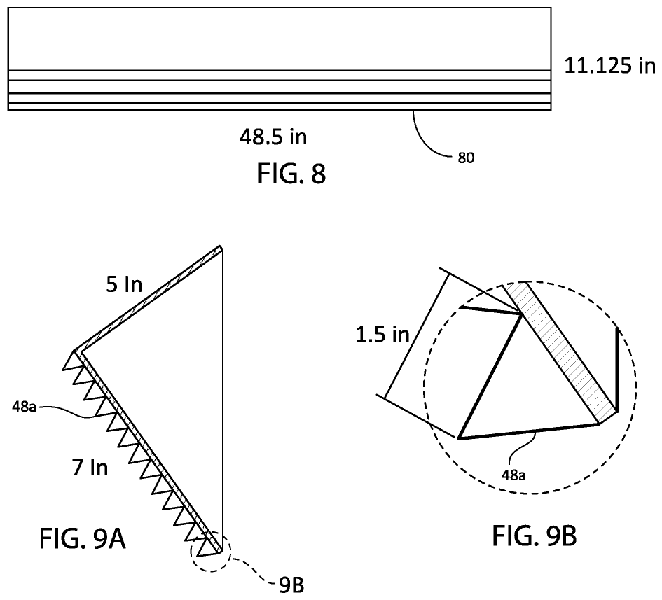

FIG. 8 shows the top view and highlighted side view of the upper weir located in chamber 2. The top view image shows the width of the baffle being around 48.5 inches and the height being about 11.125 inches.

FIG. 9 shows the side view of the corrugated corner in the lower portion of chamber 1. The corner is made up of a 90 degree angle with a short side of 5 in. and a long corrugated side of 7 in. Each individual corrugated tooth has a measurement of 1.5 inches on each side.

### Example 3

### Test Results

Water treated with the system and methods if the invention was analyzed. The test results are provided in the following table.

TABLE 1

| Analyte(s) | Result | RDL | Units | Method |
|---|---|---|---|---|
| Anions | | | | |
| Nitrate as N | 0.34 | 0.20 | mg/L | EPA 300.0 |
| Aggregate | | | | |
| Properties | | | | |
| pH | 8.0 | 1.0 | pH | SM 4500H + B |
| | | | Units | |
| Specific | 580 | 1.0 | umhos/ | SM 2510 B |
| Conductance | | | cm | |
| Solids | | | | |
| Settleable Solids | 1.0 | 0.1 | mL/L | SM 2540F |
| Aggregate | | | | |
| Organic | | | | |
| Compounds | | | | |
| Biochemical | 13 | 5.0 | mg/L | SM 5210B |
| Oxygen Demand | | | | |
| Chemical | 50 | 10 | mg/L | SM 5220D |
| Oxygen Demand | | | | |
| Phenols | ND | 0.020 | mg/L | EPA 420.4 |
| General | | | | |
| Inorganics | | | | |
| Dissolved | 8.5 | 0.10 | mg/L | SM4500 O C |
| Oxygen | | | | |
| Nutrients | | | | |
| Ammonia- | 1.7 | 0.10 | mg/L | SM4500NH3H |
| Nitrogen | | | | |
| Ammonium as | 2.2 | 0.13 | mg/L | SM4500NH3H |
| NH4 | | | | |
| Total Phosphorus | 0.29 | 0.05 | mg/L | SM 4500P B E |

As a comparison, results from the system in the prior art (U.S. Pat. No. 4,139,471) are provided below:

Process Utilized: Aerobic and anaerobic.
Tank Dimensions: 10′ long; 4′6″ high; 4′ wide.
Liquid Capacity: 1050 gallons.

### Treatment Capacity:

Hydraulic Loading: Zero flow: minimum.
Average daily flow, 500 gallons.
Peak flow 1.1 gallons per minute.

### Organic Loading:

| | influent | influent |
|---|---|---|
| parameter | mg/L, avg. | #/day |
| BOD (5 day) | 225 | 0.94 |
| Total Suspended Solids | 225 | 0.94 |

### Effluent Limitations:

| | | | system's design |
|---|---|---|---|
| | | | removal |
| | effluent | | capacity, |
| parameter | mg/L | #/day | #/day |
| BOD (5 day) | 75 | 0.31 | 1.0 |
| Total Suspended | 75 | 0.31 | 1.0 |
| Solids | | | |

| | |
|---|---|
| pH range | 6.5 to 8.5 |

The following table provides a side-by-side comparison of test results from the prior art (U.S. Pat. No. 4,139,471) with test results from the instant invention.

TABLE 2

| Old System results | New System results |
|---|---|
| Nitrate: 45.0 | Nitrate: 0.34 |
| pH 6.5-8.5 | pH: 8 |
| Suspended Solids: 75 | Suspended Solids: 1.0 |
| BOD: 75 | BOD: 13 |
| COD: 196 | COD: 50 |

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the invention disclosed herein are illustrative of the principles of the embodiments of the invention. Other modifications that can be employed can be within the scope of the invention. Thus, by way of example, but not of limitation, alternative configurations of the embodiments of the invention can be utilized in accordance with the teachings herein. Accordingly, embodiments of the present invention are not limited to that precisely as shown and described.

What is claimed is:

1. A system for purifying a waste product comprising an operating cycle used in a sewage treatment apparatus;
wherein the sewage treatment apparatus comprises a sewage treatment unit comprising a first chamber and a second chamber
wherein the first chamber and an aeration portion of the second chamber are capable of aerating the raw sewage and
wherein the operating cycle comprises aeration for aerobic treatment for 8 to 12 hours and anaerobic treatment for 12 to 16 hours.

2. The system of claim 1 further comprising a disinfecting unit.

3. The system of claim 2, wherein the disinfecting unit is a UV disinfecting unit.

4. The system of claim 1 further comprising a telemetry system.

5. The system of claim 4, wherein the telemetry system communicates with a data system.

6. The system of claim 1, wherein a cloud based web application monitors the system.

7. The system of claim 6, wherein the cloud based web application monitors one or more parameters selected from the group consisting of: monitor water flow, broken sump pump, blowers, and disinfection unit(s).

8. The system of claim 1, wherein the waste product is raw sewage.

9. The system of claim 1, wherein pumping of the waste product or output water is not required.

10. The system of claim 1, wherein the system produces an output water suitable for crops or irrigation.

11. A method for processing a waste product comprising
passing water through the system of claim 1, wherein aeration occurs in the first chamber and in an aeration portion of the second chamber, wherein settling and recirculation of solids occurs in a settling portion of the second chamber, and wherein any remaining solids are exposed repeatedly to agitation and aeration until the solids are broken down into liquid components,
wherein aeration is of a duration sufficient to promote aerobic microorganism processes that promote processing of the waste,
wherein a cessation of aeration during a period of time is sufficient to promote the action of anaerobic microorganisms that also promote processing of the waste.
wherein the operating cycle comprises alternating between aeration and non-aeration
wherein the method produces output water that is a substantially solids-free and contaminant-free.

12. The method of claim 11, wherein pumping of the waste product or output water is not required.

13. The method of claim 11, wherein the output water is suitable for reuse.
